(19) United States
(12) Patent Application Publication
(10) Pub. No.: US 2025/0131857 A1
(43) Pub. Date: Apr. 24, 2025

(54) MAILING WAYBILL

(71) Applicant: CHIME Beauty Co., Ltd., Taichung City (TW)

(72) Inventors: Bi-Ling Chen Huang, Taichung City (TW); George Chen, Taichung City (TW)

(21) Appl. No.: 18/923,564

(22) Filed: Oct. 22, 2024

(30) Foreign Application Priority Data
Oct. 23, 2023 (TW) 112140434

(51) Int. Cl. G09F 3/02

(52) U.S. Cl. CPC G09F 3/0288; G09F 2003/0226; G09F 2003/0245; G09F 2003/0257; G09F 2003/0269

(57) ABSTRACT

A mailing waybill includes a body and a release film. The body has a first surface and a bonding surface opposite to the first surface. The release film is arranged on the bonding surface. The first surface has an easily torn line, such that a first area easy to tear is divided from the first surface. According to the mailing waybill in the present invention, personal information on the mailing waybill is easier to be cleared.

### CROSS-REFERENCE TO RELATED APPLICATION

This application claims the priority benefit of Taiwan application No. 112140434, filed on Oct. 23, 2023. The entirety of the above-mentioned patent application is hereby incorporated by reference herein and made a part of this specification.

### FIELD OF THE INVENTION

The present invention relates to a bill, in particular to a mailing waybill.

### BACKGROUND OF THE INVENTION

In order to prevent letters or parcels from being unable to be delivered to designated sites due to missing of mailing waybills during mailing processes, the common mailing waybills are firmly fixed to outer surfaces of the letters or parcels, and thus the mailing waybills are difficult to remove. Personal information is recorded on the mailing waybills, and thus there is a risk of leakage if the personal information is not completely cleared.

### SUMMARY OF THE INVENTION

According to a mailing waybill in the present invention, personal information on the mailing waybill is easier to be cleared.

The mailing waybill provided in the present invention includes a body and a release film. The body has a first surface and a bonding surface opposite to the first surface. The release film is arranged on the bonding surface. The first surface has an easily torn line, such that a first area easy to tear is divided from the first surface.

In an embodiment of the present invention, the mailing waybill further includes a first symbol mark, and the first symbol mark is arranged in the first area.

In an embodiment of the present invention, the first symbol mark indicates the personal information, and the first symbol mark includes an address, phone numbers and a name.

In an embodiment of the present invention, the first surface further includes a second area adjacent to the first area, the mailing waybill further includes a second symbol mark, and the second symbol mark is arranged in the second area.

In an embodiment of the present invention, by means of the easily torn line, the second area forms an area easy to tear.

In an embodiment of the present invention, the body includes a surface layer and a bottom layer which are stacked, the surface layer has the first surface and a second surface opposite to the surface layer, the bottom layer has the bonding surface and a third surface opposite to the bonding surface and the second surface is connected to the third surface.

In an embodiment of the present invention, the body is of a single-layer structure.

In an embodiment of the present invention, the first surface further has a second area adjacent to the first area, part of the bonding surface corresponding to the first area has a first viscosity, part of the bonding surface corresponding to the second area has a second viscosity, and the first viscosity is less than the second viscosity.

In an embodiment of the present invention, the mailing waybill further includes a bottom film arranged between the part of the bonding surface corresponding to the first area and the release film, and a surface of the bottom film in contact with the release film has no viscosity.

The mailing waybill in the present invention has the first area easy to tear, such that the first symbol mark (for example, the personal information) arranged in the first area is easier to be cleared.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a three-dimensional exploded view of a mailing waybill in an embodiment of the present invention.

FIG. 2 is a three-dimensional view of a body in FIG. 1 bonded to an outer surface of a parcel.

FIG. 3 is a three-dimensional exploded view of a mailing waybill in another embodiment of the present invention.

FIG. 4 is a three-dimensional exploded view of a mailing waybill in another embodiment of the present invention.

FIG. 5 is a three-dimensional exploded view of a mailing waybill in another embodiment of the present invention.

FIG. 6 is a three-dimensional view of a body in FIG. 5 bonded to an outer surface of a parcel.

### DETAILED DESCRIPTION OF PREFERRED EMBODIMENTS

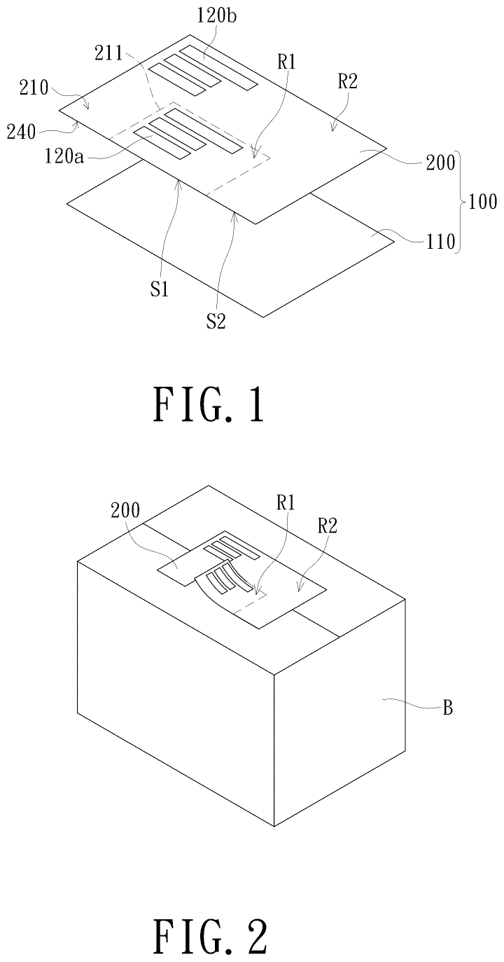

FIG. 1 is a three-dimensional exploded view of a mailing waybill in an embodiment of the present invention. FIG. 2 is a three-dimensional view of a body in FIG. 1 bonded to an outer surface of a parcel. Referring to FIG. 1 and FIG. 2, the mailing waybill 100 in this embodiment includes a body 200 and a release film 110. The body 200 has a first surface 210 and a bonding surface 240 which are opposite to each other. The release film 110 is arranged on the bonding surface 240. The first surface 210 has an easily torn line 211, such that a first area R1 easy to tear is divided from the first surface 210. The body 200 in this embodiment, for example, is of a single-layer structure. Specifically, the body 200 in this embodiment is bonded to the release film 110 by means of the bonding surface 240; and if the body 200 is separated from the release film 110, the body 200 can be bonded to an outer surface of a letter or an outer surface of a parcel by means of the bonding surface 240. As shown in FIG. 2, the body 200, for example, is bonded to the outer surface of the parcel B. The body 200 and the release film 110 in this embodiment, for example, are square, but the present invention is not limited thereto.

The first surface 210 of the body 200 in this embodiment is provided with the easily torn line 211, such that a user can easily separate the first area R1. The easily torn line 211 in this embodiment, for example, continuously cuts the body 200 along a preset route, but this is not specifically limited in the present invention. In another embodiment, the easily torn line 211 can cut the body 200 at intervals along a preset route. There is, for example, one easily torn line 211 in this embodiment, and said line has three edges. However, this is not limited in the present invention, and the number, shape and arrangement position of the easily torn line 211 can be adjusted according to actual needs.

The mailing waybill 100 in this embodiment, for example, further includes a first symbol mark 120a, and the first symbol mark 120a, for example, is arranged in the first area R1. Specifically, the first symbol mark 120a, for example, indicates the personal information, and the first symbol mark 120a, for example, includes an address, phone numbers and a name of a recipient; and through arrangement of the easily torn line 211, it can be more convenient to remove the first symbol mark 120a arranged in the first area R1, thereby avoiding leakage of the personal information, but this is not specifically limited in the present invention.

In this embodiment, the first surface 210, for example, further includes a second area R2 adjacent to the first area R1, the mailing waybill 100, for example, further includes a second symbol mark 120b, and the second symbol mark 120b can be arranged in the second area R2. The second symbol mark 120b can indicate personal information of a sender, for example, an address, phone numbers and a name, but the present invention is not limited to this.

In another embodiment, the second symbol mark 120b (for example, the personal information) can be arranged in the first area R1 (not shown), and then the first symbol mark 120a and the second symbol mark 120b can be cleared at the same time when the first area R1 is removed.

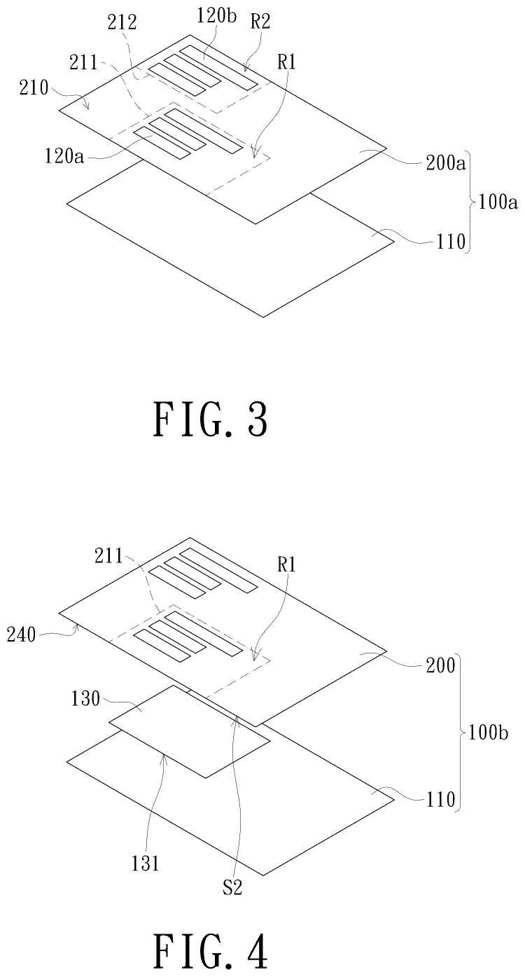

FIG. 3 is a three-dimensional exploded view of a mailing waybill in another embodiment of the present invention. Referring to FIG. 3, there are multiple easily torn lines in this embodiment, for example, the easily torn lines 211, 212. The easily torn line 211, for example, sets the first area R1 as an area easy to tear, the easily torn line 212, for example, also sets the second area R2 as an area easy to tear, and thus it is more convenient to clear the second symbol mark 120b arranged in the second area R2.

In addition, continuously referring to FIG. 1 and FIG. 2. In this embodiment, part of the bonding surface 240 corresponding to the first area R1, for example, has a first viscosity S1, part of the bonding surface 240 corresponding to the second area R2, for example, has a second viscosity S2, and the first viscosity S1, for example, is less than the second viscosity S2. For example, in this embodiment, the first viscosity S1, for example, is set to be less than the second viscosity S2, thus it is easier to tear the first area R1 from the outer surface of the parcel B, but this is not specifically limited in the present invention. In an embodiment, the first viscosity S1 may even has no adhesion (that is, the first viscosity S1, for example, is zero), which makes the first area R1 easier to tear.

FIG. 4 is a three-dimensional exploded view of a mailing waybill in another embodiment of the present invention. Please refer to FIG. 1 and FIG. 4. The mailing waybill 100b in this embodiment is similar to the mailing waybill 100 in the embodiment as shown in FIG. 1, and the main differences lie in that the mailing waybill 100b can further include a bottom film 130, for example, arranged between the part of the bonding surface 240 corresponding to the first area R1 and the release film 110, and a surface 131 of the bottom film 130 in contact with the release film 110, for example, has no viscosity. Specifically, the bonding surface 240 of the body 200, for example, has the second viscosity S2, and the surface 131 of the bottom film 130, for example, has no viscosity. Thus, when the bottom film 130 is arranged on the part of the bonding surface 240 corresponding to the first area R1, due to the low adhesion between the surface 131 and the release film 110, it is easier to tear the first area R1 corresponding to the bottom film 130. The bottom film 130 and the first area R1 in this embodiment, for example, have the same sizes, but this is not specifically limited in the present invention. In another embodiment, the bottom film 130 and the first area R1, for example, have the different sizes or dimensions.

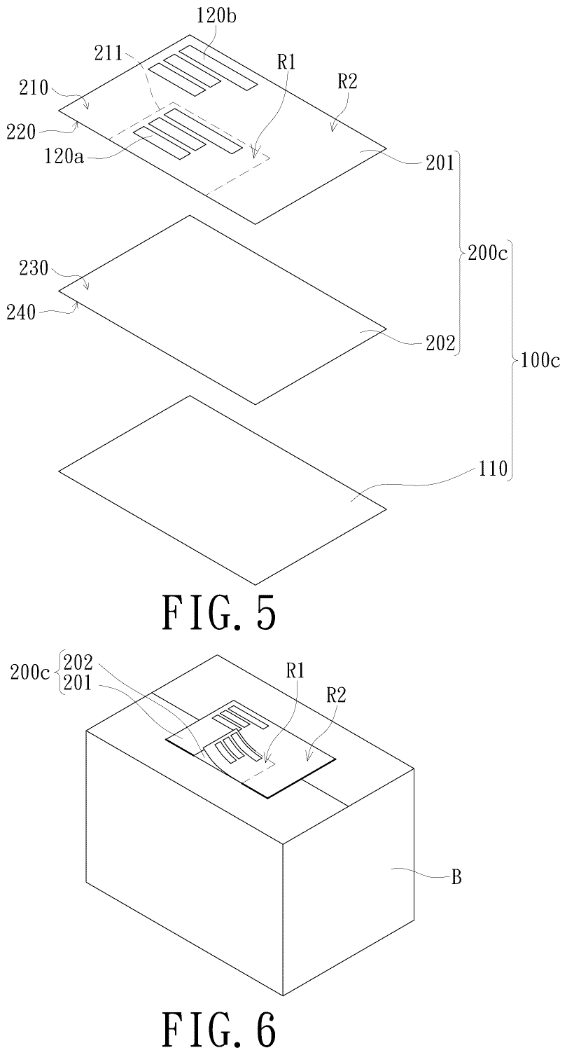

FIG. 5 is a three-dimensional exploded view of a mailing waybill in another embodiment of the present invention. FIG. 6 is a three-dimensional view of a body in FIG. 5 bonded to an outer surface of a parcel. Referring to FIG. 5 and FIG. 6. A body 200c in this embodiment, for example, includes a surface layer 201 and a bottom layer 202 which are stacked. The surface layer 201, for example, has the first surface 210 and a second surface 220 which are opposite to each other. The bottom layer 202, for example, has the bonding surface 240 and a third surface 230 which are opposite to each other, and the second surface 220, for example, is connected to the third surface 230. The mailing waybill 100c in this embodiment is similar to the mailing waybill 100, and the main difference lies in that the body 200c, for example, is of a double-layer structure, and the body 200 is of the single-layer structure. Specifically, compared with the fixing strength between the bonding surface 240 and the outer surface of the parcel B, if the fixing strength between the surface layer 201 and the bottom layer 202 is set to be relatively low, it is easier to separate the first area R1 from the second area R2. Thus, it is easier to remove the first area R1 due to the double-layer structure of the body 200c. However, the present invention is not limited to thereto.

Following the above, in an embodiment, the second surface 220 and the third surface 230 have no viscosity, and the second surface 220 and the third surface 230, for example, are attached to each other in an electrostatic attaching manner or other non-pasting manners. Thus, the second surface 220 or the third surface 230 can be prevented from being attached to other objects after the first area R1 is torn. However, this is not specifically limited in the present invention. In addition, the easily torn line 211 in this embodiment, for example, continuously cuts the surface layer 201 of the body 200c along a preset route, but this is not specifically limited in the present invention. In another embodiment, the easily torn line 211 can cut the surface layer 201 of the body 200c at intervals along a preset route. In another embodiment, the easily torn line 211 can cut the surface layer 201 and the bottom layer 202 at the same time.

The mailing waybill 100c in this embodiment has the first area R1 easy to tear, such that the first symbol mark 120a (for example, the personal information) arranged in the first area R1 is easier to be cleared. In addition, the body 200c including the surface layer 201 and the bottom layer 202 make it easier to remove the first area R1.

In conclusion, the mailing waybill in the present invention has the first area easy to tear, such that the first symbol mark (for example, the personal information) arranged in the first area is easier to be cleared.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mailing waybill, comprising:
a body, the body having a first surface and a bonding surface opposite to the first surface; and
a release film arranged on the bonding surface;
wherein the first surface has an easily torn line, such that a first area easy to tear is divided from the first surface.

2. The mailing waybill according to claim 1, further comprising a first symbol mark arranged in the first area.

3. The mailing waybill according to claim 2, wherein the first symbol mark indicates personal information, and the first symbol mark comprises an address, phone numbers and a name.

4. The mailing waybill according to claim 1, wherein the first surface further comprises a second area adjacent to the first area, and the mailing waybill further comprises a second symbol mark arranged in the second area.

5. The mailing waybill according to claim 1, wherein by means of the easily torn line, the second area forms an area easy to tear.

6. The mailing waybill according to claim 1, wherein the body comprises a surface layer and a bottom layer which are stacked, the surface layer has the first surface and a second surface opposite to the first surface, the bottom layer has the bonding surface and a third surface opposite to the bonding surface, and the second surface is connected to the third surface.

7. The mailing waybill according to claim 1, wherein the body is of a single-layer structure.

8. The mailing waybill according to claim 7, wherein the first surface further has a second area adjacent to the first area, part of the bonding surface corresponding to the first area has a first viscosity, part of the bonding surface corresponding to the second area has a second viscosity, and the first viscosity is less than the second viscosity.

9. The mailing waybill according to claim 7, further comprising a bottom film arranged between the part of the bonding surface corresponding to the first area and the release film, wherein a surface of the bottom film in contact with the release film has no viscosity.
